(19) United States
(12) Patent Application Publication
(10) Pub. No.: US 2026/0032181 A1
(43) Pub. Date: Jan. 29, 2026

(54) RELAY DEVICE, COMMUNICATION CONTROL METHOD, AND COMMUNICATION CONTROL PROGRAM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(72) Inventors: Yusuke YAMAMOTO, Osaka-shi (JP); Tatsuya IZUMI, Osaka-shi (JP); Hideyuki TANAKA, Osaka-shi (JP); Yoshio ITO, Osaka-shi (JP); Ryo YAMANE, Osaka-shi (JP); Kenta OGATA, Osaka-shi (JP); Makoto CHUJO, Osaka-shi (JP); Darmawan GO, Yokkaichi-shi (JP); Yoshitaka KIKUCHI, Yokkaichi-shi (JP); Hirofumi URAYAMA, Yokkaichi-shi (JP); Yasuhiro YAMASAKI, Toyota-shi (JP); Hideki GOTO, Toyota-shi (JP); Ikuyoshi OTAKE, Toyota-shi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(21) Appl. No.: 18/997,675

(22) PCT Filed: Jun. 9, 2023
(86) PCT No.: PCT/JP2023/021483

§ 371 Date: Jan. 22, 2025

(30) Foreign Application Priority Data
Aug. 2, 2022 (JP) 2022-123580

(51) Int. Cl. H04L 67/562; H04L 12/46; H04L 67/12

(52) U.S. Cl. CPC H04L 67/562; H04L 12/46; H04L 67/12

(57) ABSTRACT

A relay device for use in an in-vehicle network that includes a plurality of functional units, wherein the in vehicle network including a first network and a second network, the relay device includes: a relay unit configured to performs relay processing to relay frames transmitted and received between the functional units in the first network and the functional units in the second network, and frames transmitted and received between a plurality of the functional units in the second network; and a proxy processing unit configured to act as a proxy for the plurality of functional units in the second network by operating as a communication partner of the functional units in the first network in communicating information regarding setting processing for performing communication in the in-vehicle network.

### TECHNICAL FIELD

The present disclosure relates to a relay device, a communication control method, and a communication control program.

This application is based upon and claims the benefit of priority from Japanese patent application No.2022-123580 filed on Aug. 2, 2022 the disclosure of which is incorporated herein in their entirety by reference.

### BACKGROUND ART

Patent Document 1 (WO 2020/145334) discloses the following technology. That is to say, a vehicle control apparatus controls a plurality of relay devices based on a control scenario associating the state of a vehicle, within which a vehicle network is formed by the relay devices, with the control content to be set to each of the relay devices.

### CITATION LIST

### Patent Document

Patent Document 1: WO 2020/145334
Patent Document 2: JP 2016-163244A
Patent Document 3: WO 2020/179123
Patent Document 4: WO 2020/27182

### SUMMARY OF THE INVENTION

A relay device according to the present disclosure is a relay device for use in an in-vehicle network that includes a plurality of functional units, wherein the in-vehicle network including a first network and a second network, the relay device including: a relay unit configured to performs relay processing to relay frames transmitted and received between the functional units in the first network and the functional units in the second network, and frames transmitted and received between a plurality of the functional units in the second network; and a proxy processing unit configured to act as a proxy for the plurality of functional units in the second network by operating as a communication partner of the functional units in the first network in communicating information regarding setting processing for performing communication in the in-vehicle network.

One aspect of the present disclosure can be realized as a semiconductor integrated circuit that realizes a part or the entirety of the relay device, or a system that includes the relay device.

### BRIEF DESCRIPTION OF THE DRAWINGS

FIG. 1 is a diagram showing a configuration of an in-vehicle communication system according to an embodiment of the present disclosure.

FIG. 2 is a diagram showing a configuration of the relay device according to the embodiment of the present disclosure.

FIG. 3 is a diagram showing an example of communication performed in the in-vehicle communication system according to the embodiment of the present disclosure.

FIG. 4 is a diagram showing an example of information held by the relay device that changes network settings in the in-vehicle communication system according to the embodiment of the present disclosure.

FIG. 5 is a diagram showing an example of functional unit information in the in-vehicle communication system according to the embodiment of the present disclosure.

FIG. 6 is a diagram showing another example of functional unit information in the in-vehicle communication system according to the embodiment of the present disclosure.

FIG. 7 is a diagram showing an example of information held by the relay device that includes the proxy processing unit in the in-vehicle communication system according to the embodiment of the present disclosure.

FIG. 8 is a diagram showing an example of functional unit information transmitted by the proxy processing unit in the in-vehicle communication system according to the embodiment of the present disclosure.

FIG. 9 is a diagram showing an example of information that is used to change network settings in the in-vehicle communication system according to the embodiment of the present disclosure.

FIG. 10 is a diagram showing an example of information that is used by the proxy processing unit of the relay device according to the embodiment of the present disclosure to perform processing to convert setting information.

FIG. 11 is a diagram showing an example of a sequence for changing network settings in the in-vehicle communication system according to the embodiment of the present disclosure.

FIG. 12 is a diagram showing an example of a sequence for changing network settings in the in-vehicle communication system according to the embodiment of the present disclosure.

### DESCRIPTION OF EMBODIMENTS

Technologies for changing settings of the configuration of an in-vehicle network has been developed.

### Problem to be Solved by the Invention

For example, in a configuration in which settings of a relay device or the like in an in-vehicle network are dynamically changed, the settings need to be designed in advance. When providing variations in the configuration of applications or the configuration of devices in an in-vehicle network, the number of design patterns will become enormous with an increase in the scale of the in-vehicle network.

The present disclosure has been made to solve the foregoing problem, and aims to provide a relay device, a communication control method, and a communication control program that can suppress an increase in the number of design patterns for an in-vehicle network in a configuration in which settings of the in-vehicle network are changed.

### Effects of the Present Disclosure

With the present disclosure, in a configuration in which settings of the in-vehicle network are changed, an increase in the number of design patterns of the in-vehicle network can be suppressed.

### Description of Embodiment of Present Disclosure

First, the details of an embodiment of the present disclosure are listed and described.
(1) A relay device according to an embodiment of the present disclosure is a relay device for use in an in-vehicle network that includes a plurality of functional units, wherein the in-vehicle network including a first network and a second network, the relay device including: a relay unit configured to performs relay processing to relay frames transmitted and received between the functional units in the first network and the functional units in the second network, and frames transmitted and received between a plurality of the functional units in the second network; and a proxy processing unit configured to act as a proxy for the plurality of functional units in the second network by operating as a communication partner of the functional units in the first network in communicating information regarding setting processing for performing communication in the in-vehicle network.

With this configuration, the in-vehicle network can be divided such that the divided networks can be managed separately. Thus, in a configuration in which settings of the relay device or the like in the in-vehicle network are dynamically changed, it is possible to suppress an increase in the number of design patterns with an increase in variations in the configuration of applications or the device configuration in the in-vehicle network. Accordingly, in a configuration in which settings of the in-vehicle network are changed, an increase in the number of design patterns of the in-vehicle network can be suppressed.
(2) In the above (1), a configuration is possible in which, the proxy processing unit acquires functional unit information regarding each of the functional units in the second network, generates aggregate information that is functional unit information regarding one functional unit based on the acquired functional unit information, and transmits the generated aggregate information as functional unit information regarding the relay device to the first network.

With this configuration, the relay device can aggregate the functional unit information regarding the functional units in the second network and behave as a single functional unit as viewed from the first network, making it easy to divide the in-vehicle network using the relay device.
(3) In the above (2), a configuration is possible in which, the proxy processing unit selects the functional unit information regarding each of the functional units in the second network that communicate with each of the functional units in the first network from the acquired functional unit information, and generates the aggregate information including the selected functional unit information.

With this configuration, information necessary for generating the setting information on the first network side, among the functional unit information regarding each functional unit in the second network, can be selectively provided to the first network side, thereby simplifying processing on the first network side.
(4) In the above (3), a configuration is possible in which, the relay device further including: a storage unit configured to store information indicating a correspondence relationship between the functional units in the second network and whether or not the functional units communicate with the functional units in the first network.

With this configuration, the functional unit information can be easily sorted using information that is registered in advance.
(5) In any of the above (1) to (4), a configuration is possible in which, the proxy processing unit generates setting information for each of the functional units to be subjected to the setting processing in the second network, based on the setting information received from the functional units in the first network, and transmits the generated setting information to the corresponding functional unit.

With this configuration, the relay device can expand the setting information for one functional unit given from the first network and configure settings of each functional unit in the second network, and the relay device can thus behave as one functional unit as viewed from the first network. This makes it possible to easily realize division of the in-vehicle network using the relay device.
(6) In the above (5), a configuration is possible in which, the proxy processing unit generates setting information for the relay device that is one of the functional units to be subjected to the setting processing, based on the setting information received from the functional units in the first network, and the relay device further including: a setting unit configured to perform the setting processing for the relay device, based on the setting information for the relay device that is generated by the proxy processing unit.

With this configuration, the relay device can configure settings of each functional unit in the second network, including the settings of the relay device itself, making it possible to deal with a greater variety of design patterns in the in-vehicle network.
(7) A communication control method according to an embodiment of the present disclosure is a communication control method to be performed in a relay device for use in an in-vehicle network that includes a plurality of functional units, wherein the in-vehicle network including a first network and a second network, the communication control method including: a step of performing relay processing to relay frames transmitted and received between the functional units in the first network and the functional units in the second network, and frames transmitted and received between a plurality of the functional units in the second network; and a step of acting as a proxy for the plurality of functional units in the second network by operating as a communication partner of the functional units in the first network in communicating information regarding setting processing for performing communication in the in-vehicle network.

With this configuration, the in-vehicle network can be divided such that the divided networks can be managed separately. Thus, in a configuration in which settings of the relay device or the like in the in-vehicle network are dynamically changed, it is possible to suppress an increase in the number of design patterns with an increase in variations in the configuration of applications or the device configuration in the in-vehicle network. Accordingly, in a configuration in which settings of the in-vehicle network are changed, an increase in the number of design patterns of the in-vehicle network can be suppressed.
(8) A communication control program according to an embodiment of the present disclosure is a communication control program for a relay device for use in an in-vehicle network that includes a plurality of functional units, wherein the in-vehicle network including a first network and a second network, the communication control program causing a computer to function as: a relay unit configured to performs relay processing to relay frames transmitted and received between the functional units in the first network and the functional units in the second network, and frames transmitted and received between a plurality of the functional units in the second network; and a proxy processing unit configured to act as a proxy for the plurality of functional units in the second network by operating as a communication partner of the functional units in the first network in communicating information regarding setting processing for performing communication in the in-vehicle network.

With this configuration, the in-vehicle network can be divided such that the divided networks can be managed separately. Thus, in a configuration in which settings of the relay device or the like in the in-vehicle network are dynamically changed, it is possible to suppress an increase in the number of design patterns with an increase in variations in the configuration of applications or the device configuration in the in-vehicle network. Accordingly, in a configuration in which settings of the in-vehicle network are changed, an increase in the number of design patterns of the in-vehicle network can be suppressed.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### [In-Vehicle Communication System]

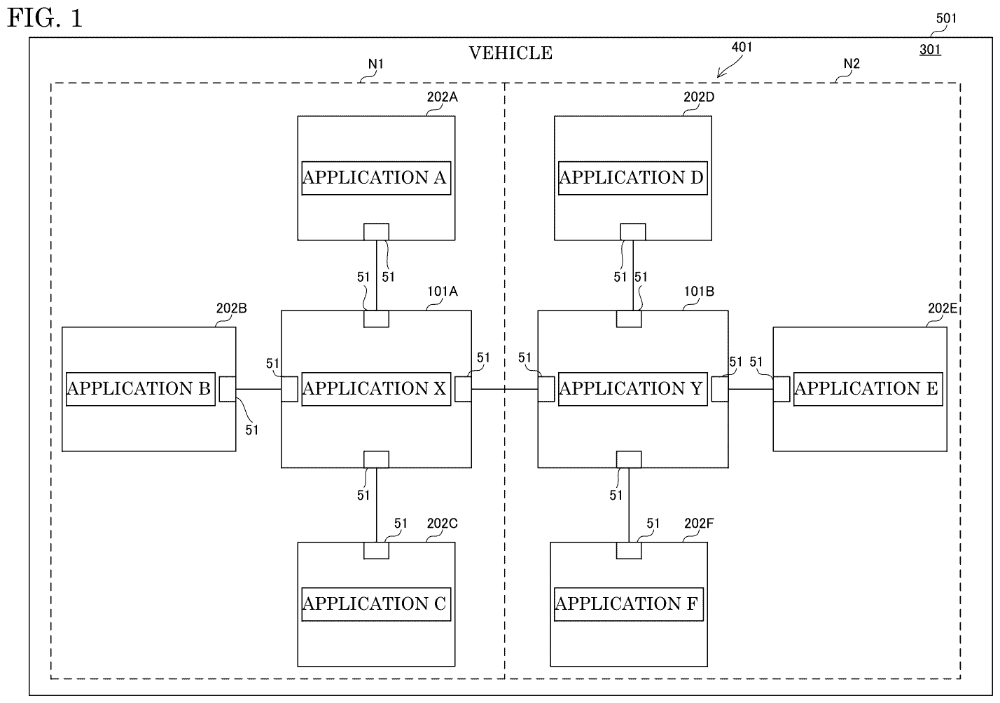

FIG. 1 is a diagram showing a configuration of an in-vehicle communication system according to an embodiment of the present disclosure. Referring to FIG. 1, an in-vehicle communication system 301 includes a plurality of in-vehicle ECUs (Electronic Control Units) 202, and a plurality of relay devices 101.

In the example shown in FIG. 1, the in-vehicle communication system 301 includes in-vehicle ECUs 202A, 202B, 202C, 202D, 202E, and 202F, which are the in-vehicle ECUs 202, and relay devices 101A and 101B, which are the relay devices 101. The in-vehicle communication system 301 is installed in a vehicle 501. The in-vehicle ECUs 202 and the relay devices 101 are examples of functional units.

The in-vehicle ECUs 202 and the relay devices 101 constitute an in-vehicle network 401. More specifically, the in-vehicle network 401 includes networks N1 and N2. The in-vehicle ECUs 202A, 202B, and 202C and the relay device 101A constitute the network N1. The in-vehicle ECUs 202D, 202E, and 202F and the relay device 101B constitute the network N2.

The in-vehicle ECUs 202A, B, C, D, E, and F include applications A, B, C, D, E, and F, respectively. The relay device 101A includes an application X, and the relay device 101B includes an application Y.

In the in-vehicle network 401, the in-vehicle ECUs 202 are connected to the relay devices 101, for example via Ethernet (registered trademark) cables.

More specifically, the relay devices 101 each include a plurality of communication ports 51. Each communication port 51 is, for example, a terminal to which an Ethernet cable can be connected. Each relay device 101 and each in-vehicle ECU 202 is connected to another relay device 101 or in-vehicle ECU 202 via the communication port 51 and an Ethernet cable. Note that the communication port 51 is not limited to a physical communication port, and may be, for example, a logical communication port defined by a VLAN (Virtual Local Area Network).

The relay devices 101 are used in the in-vehicle network 401 that includes a plurality of in-vehicle ECUs 202. Each relay device 101 is, for example, a gateway device and is capable of relaying data between a plurality of in-vehicle ECUs 202 connected thereto. The relay devices 101 can perform relay processing in accordance with Layer 2 and Layer 3, which is a higher-level layer than Layer 2, for example.

More specifically, the relay devices 101 perform relay processing for frames communicated between the in-vehicle ECUs 202, which are connected via Ethernet cables, in accordance with, for example, the Ethernet communication standard.

Note that the in-vehicle communication system 301 is not limited to a configuration in which frames are relayed according to the Ethernet communication standard. For example, it is also possible to employ a configuration in which frames are relayed in accordance with a communication standard such as CAN (Controller Area Network) (registered trademark), CAN FD (CAN with Flexible Data Rate), FlexRay (registered trademark), MOST (Media Oriented Systems Transport) (registered trademark), or LIN (Local Interconnect Network).

The in-vehicle ECUs 202 are, for example, an autonomous driving ECU, an engine ECU, a sensor, a navigation device, a human machine interface, a camera, and the like.

Each relay device 101 and each in-vehicle ECU 202 generates a frame that includes various types of information, which will be described later, and transmits the generated frame to another in-vehicle ECU 202 or relay device 101.

When a predetermined event occurs, the relay device 101A changes settings of the in-vehicle network 401 (hereinafter also referred to as “network setting change”), as will be described later. Hereinafter, the in-vehicle network 401 after reflecting the network setting change will also be referred to as a new network.

The relay device 101A acquires functional unit information regarding a plurality of functional units in the in-vehicle network that includes, for example, information relating to the network configuration in lower-level layers than the application layer.

More specifically, the relay device 101A acquires functional unit information regarding each functional unit, e.g., each in-vehicle ECU 202, upon the occurrence of a predetermined event that triggers a network setting change. Note that the relay device 101A may alternatively be configured to acquire functional unit information regarding at least either the relay device 101A or the relay device 101B in addition to or instead of functional unit information regarding each in-vehicle ECU 202.

The relay device 101B operates as a proxy for the in-vehicle ECUs 202 in the network N2. Thus, the relay device 101A is not aware of the presence of the network N2, but recognizes the relay device 101B as one functional unit and performs various types of processing.

The aforementioned event refers to, for example, a case where a user performs a predetermined operation to an in-vehicle ECU 202 that is a navigation device. Note that the event may also be a case where a new functional unit is added to the in-vehicle network 401, specifically, a case where an in-vehicle ECU 202 is added to the in-vehicle network 401, or a case where a new application is installed in an existing in-vehicle ECU 202 in the in-vehicle network 401. Thus, the functional units may be hardware or software.

For example, the relay device 101A acquires, as functional unit information, information from which at least one of the following types of information can be recognized: i.e., the specifications of hardware devices, such as the in-vehicle ECUs 202 and the relay devices 101 in the new network; the topology of the new network; constraints on the placement of applications in the hardware devices in the new network; and constraints on the communication method in the new network.

For example, the relay device 101A acquires, as the information from which the specifications of the hardware devices and the topology of the new network can be recognized, at least one of the following types of information: i.e., information regarding: an identifier, a name, a device type indicating a sensor type or the like, memory size, the number of physical ports provided for each communication protocol, a physical port identifier, a power supply configuration, power consumption, a VLAN ID, a subnet address, and a functional domain of each hardware device; information regarding the specifications of a CPU or a GPU (Graphics Processing Unit) installed in each hardware device; information regarding the connection relationship between the hardware devices; information regarding the bandwidth used in communication between the hardware devices; and information regarding the specifications of the relay devices 101.

For example, the relay device 101A acquires, as information from which constraints on the placement of applications in the hardware devices can be recognized, at least one of the following types of information: i.e., information regarding the calculation speed required for execution; memory usage; an OS (Operating System) environment constraints; and constraints on communication protocols such as TCP (Transmission Control Protocol) and UDP (User Datagram Protocol) of each application in the in-vehicle ECUs 202 and the relay devices 101.

The relay device 101A acquires, as information from which constraints on the communication method in the new network can be recognized, at least one of the following types of information: i.e., information regarding communication data size; communication frequency; whether burst transmission is required; allowable delay time; allowable amount of loss; required security level; a communication type indicating operation timing, such as whether communication is periodic or irregular; an identifier of an application to be a communication partner; and a messaging method indicating a request-response type or a publish-subscribe type, or the like, of each application in the in-vehicle ECUs 202 and the relay devices 101, and the priority of communication performed by each application.

For example, the relay device 101A specifies one or more types of functional unit information that are necessary for generating setting information for the new network out of the aforementioned types of functional unit information.

The relay device 101A transmits an information request notification indicating that the specified type of functional unit information is to be transmitted, for example, to each functional unit in the network N1 and the relay device 101B.

Each functional unit in the network N1 transmits its own functional unit information of the type specified in the information request notification to the relay device 101A in response to the information request notification received from the relay device 101A.

The relay device 101B transmits the functional unit information of the type specified in the information request notification to the relay device 101A in response to the information request notification received from the relay device 101A.

Further, for example, the relay device 101A references the storage unit in the relay device 101A and acquires the specified type of the functional unit information regarding the relay device 101A from the storage unit.

### [Relay Device 101B]

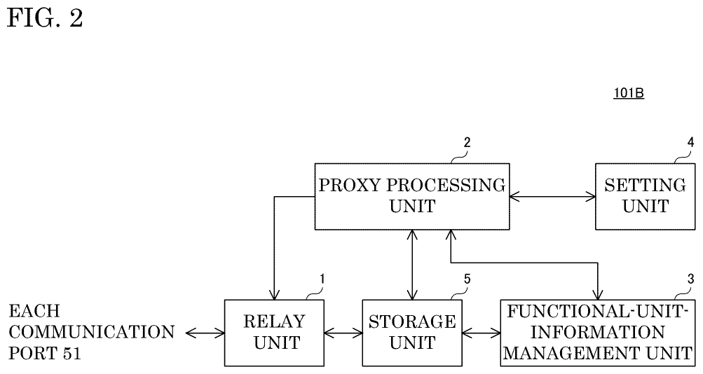

FIG. 2 is a diagram showing a configuration of the relay device according to the embodiment of the present disclosure. FIG. 2 shows the configuration of the relay device 101B shown in FIG. 1.

Referring to FIG. 2, the relay device 101B includes a relay unit 1, a proxy processing unit 2, a functional-unit-information management unit 3, a setting unit 4, and a storage unit 5. Some or all of the relay unit 1, the proxy processing unit 2, the functional-unit-information management unit 3, and the setting unit 4 are realized, for example, by a circuitry including one or more processors. The storage unit 5 is, for example, a nonvolatile memory included in the circuitry.

The relay unit 1 performs relay processing to relay frames transmitted and received between the functional units. That is, the relay unit 1 performs relay processing to relay frames transmitted and received between the functional units in the network N1 and the functional units in the network N2, as well as frames transmitted and received between a plurality of functional units in the network N2. Specifically, when the relay unit 1 receives a frame from one in-vehicle ECU 202 or the relay device 101A, the relay unit 1 transmits the received frame to the destination in-vehicle ECU 202 or relay device 101A.

The proxy processing unit 2 acts as a proxy for a plurality of functional units in the network N2 by acting as a communication partner with the functional units in the network N1 in communicating information regarding setting processing for performing communication in the in-vehicle network 401.

The proxy processing unit 2 acquires functional unit information regarding each functional unit in the network N2. For example, the proxy processing unit 2 acquires functional unit information regarding a plurality of functional units in the in-the network N2 that includes information relating to the network configuration in lower-level layers than the application layer.

More specifically, the proxy processing unit 2 receives an information request notification for the relay device 101B from the relay device 101A, generates an information request notification for each functional unit, such as each in-vehicle ECU 202, in the network N2, and transmits the generated information request notification to the in-vehicle ECU 202 via the relay unit 1. This information request notification indicates that functional unit information of the type specified by the relay device 101A is to be transmitted.

In response to the information request notification received from the relay device 101B, each in-vehicle ECU 202 transmits its own functional unit information of the type specified in the information request notification to the relay device 101B.

Note that the proxy processing unit 2 may be configured to acquire functional unit information regarding the relay device 101B, which is an example of the functional unit, in addition to or instead of functional unit information regarding each in-vehicle ECU 202. In this case, the proxy processing unit 2 outputs the information request notification to the functional-unit-information management unit 3.

The functional-unit-information management unit 3 receives the information request notification from the proxy processing unit 2, references the storage unit 5, acquires from the storage unit 5 the functional unit information regarding the relay device 101B of the type specified in the information request notification, and outputs the acquired functional unit information to the proxy processing unit 2.

In response to the information request notification received from the relay device 101A, the proxy processing unit 2 transmits the functional unit information of the type specified in the information request notification to the relay device 101A.

More specifically, the proxy processing unit 2 generates aggregate information, which is functional unit information regarding one functional unit, based on each piece of acquired functional unit information, and transmits the generated aggregate information as the functional unit information regarding the relay device 101B to the network N1. Specifically, for example, the proxy processing unit 2 aggregates the functional unit information, which corresponds to communication requests from the functional units in the network N2, and notifies the network N1 of aggregated information.

The relay device 101A generates setting information for each functional unit in a new network based on each piece of the acquired functional unit information.

More specifically, the relay device 101A determines a target functional unit that is to be subjected to a setting change for performing communication in the new network. In this example, the target functional unit is at least either a relay device 101 or an in-vehicle ECU 202. The relay device 101A then transmits the generated setting information to the target functional unit. If the target functional unit is the relay device 101A itself, the relay device 101A changes various settings of its own in accordance with the generated setting information.

For example, based on the acquired functional unit information, the relay device 101A generates setting information including filtering, communication bandwidth, frame priority, and VLAN settings in the relay device 101, as well as settings of the target functional unit for the in-vehicle ECUs 202 and the relay devices 101A and 101B to communicate in the new network, such as VLAN settings and frame data size in the in-vehicle ECUs 202. That is, the setting information includes at least one of filtering, communication bandwidth, frame priority, and the VLAN setting in the relay device 101, and VLAN settings and frame data size in the in-vehicle ECUs 202, which are the functional units.

Based on the setting information received from the functional units in the network N1, the proxy processing unit 2 generates setting information for each functional unit that is to be subjected to setting processing in the network N2, and transmits the generated setting information to the corresponding functional unit.

That is, the proxy processing unit 2 accepts a setting change request from the network N1, converts the received setting change request into a setting change request for a functional unit in the network N2, and makes the setting change request to this functional unit.

If the setting information received from the relay device 101A includes settings of an in-vehicle ECU 202, the proxy processing unit 2 transmits a frame including setting information indicating the settings to the in-vehicle ECU 202 that is the corresponding target functional unit.

The in-vehicle ECU 202 receives the setting information from the relay device 101A or the relay device 101B, and changes various settings in accordance with the received setting information. After completing the setting change, the in-vehicle ECU 202 transmits a completion response to the relay device 101A or the relay device 101B.

If, for example, the setting information received from the relay device 101A includes settings of the relay device 101B, i.e., if the relay device 101B is the target functional unit, the proxy processing unit 2 generates setting information for the relay device 101B based on the setting information received from the functional units in the network N1. The proxy processing unit 2 outputs the generated setting information for the relay device 101B to the setting unit 4.

The setting unit 4 performs setting processing for the relay device 101B based on the setting information for the relay device 101B that is generated by the proxy processing unit 2. That is, the setting unit 4 changes various settings of the relay device 101B in accordance with the setting information received from the proxy processing unit 2. After completing the setting change, the setting unit 4 outputs a completion response to the proxy processing unit 2.

The in-vehicle ECUs 202 and the relay devices 101A and 101B in the new network communicate with each other in accordance with the changed settings.

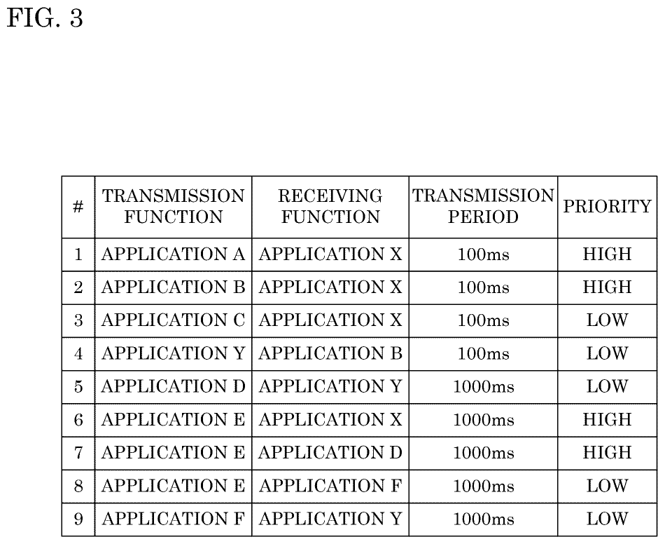

FIG. 3 is a diagram showing an example of communication performed in the in-vehicle communication system according to the embodiment of the present disclosure.

Referring to FIG. 3, in the in-vehicle communication system 301, applications A, B, and C serve to transmit information, an application X serves to receive information, the transmission period is 100 milliseconds, and the priority of communication is “high”, “high” and “low”, respectively. An application Y serves to transmit information, the application B serves to receive information, the transmission period is 100 milliseconds, and the priority of communication is “low”. An application

D serves to transmit information, the application Y serves to receive information, the transmission period is 1000 milliseconds, and the priority of communication is “low”. An application E serves to transmit information, the applications X, D, and F serve to receive information, the transmission period is 1000 milliseconds, and the priority of communication is “high”, “high”, and “low”, respectively. The application F serves to transmit information, the application Y serves to receive information, the transmission period is 1000 milliseconds, and the priority of communication is “low”.

For example, communication with row numbers 1 to 9 is performed independently. When pairs of transmission functions and receiving functions exist in the in-vehicle network as described above, functional unit information that corresponds to a communication request is transmitted from each functional unit.

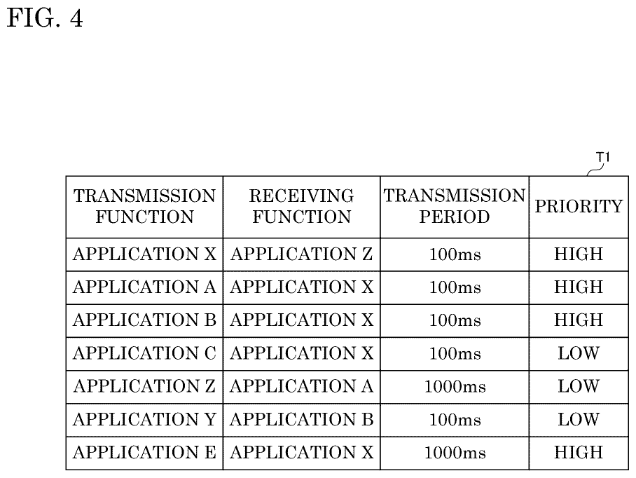

FIG. 4 is a diagram showing an example of information held by the relay device that changes network settings in the in-vehicle communication system according to the embodiment of the present disclosure.

Referring to FIG. 4, the relay device 101A holds a communication management table T1, which indicates the content of communication that is active in the in-vehicle network.

Communication with row numbers 1, 2, 3, 4, and 6 in FIG. 3 is registered in the communication management table T1. In addition, communication is also registered in which the application X serves to transmit information, an application Z (not shown) serves to receive information, the transmission period is 100 milliseconds, and the priority of communication is “high”. Further, communication is also registered in which the application Z serves to transmit information, the application A serves to receive information, the transmission period is 1000 milliseconds, and the priority of communication is “low”.

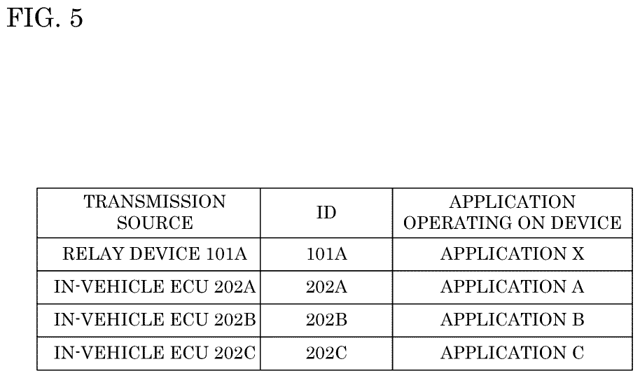

FIG. 5 is a diagram showing an example of functional unit information in the in-vehicle communication system according to the embodiment of the present disclosure. FIG. 5 shows functional unit information from the functional units in the network N1.

Specifically, referring to FIG. 5, the relay device 101A acquires, from its own storage unit, functional unit information indicating that the relay device 101A is a transmission source and the application X is an application operating on the device. The relay device 101A also acquires functional unit information indicating that the in-vehicle ECUs 202A, 202B, and 202C are transmission sources and the applications A, B, and C are applications operating on the respective devices.

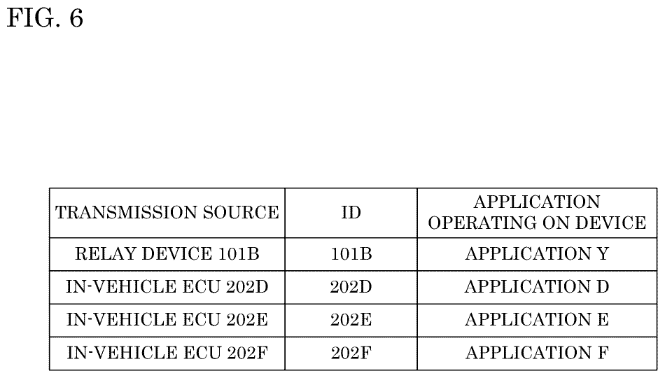

FIG. 6 is a diagram showing another example of functional unit information in the in-vehicle communication system according to the embodiment of the present disclosure. FIG. 6 shows functional unit information from the functional units in the network N2.

Specifically, referring to FIG. 6, the proxy processing unit 2 of the relay device 101B acquires, from the functional-unit-information management unit 3, functional unit information indicating that the relay device 101B is a transmission source and the application Y is an application operating on the device. The proxy processing unit 2 also acquires functional unit information indicating that the in-vehicle ECUs 202D, 202E, and 202F are transmission sources and the applications D, E, and F are applications operating on the respective functional units.

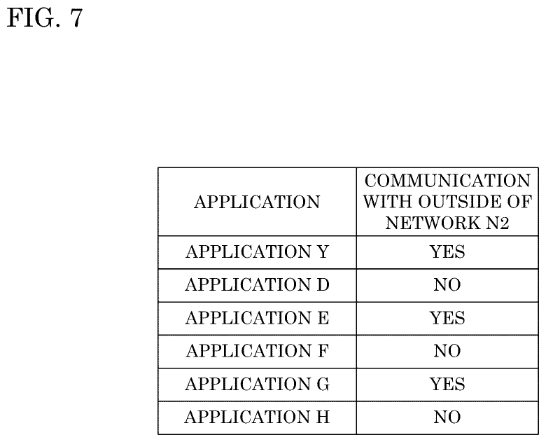

FIG. 7 is a diagram showing an example of information held by the relay device that includes the proxy processing unit in the in-vehicle communication system according to the embodiment of the present disclosure.

Referring to FIG. 7, the storage unit 5 stores information indicating the correspondence relationship between the functional units in the network N2 and whether or not these functional units communicate with the functional units in the network N1.

Specifically, in a communication/non-communication table T2, the applications Y, E, and G, among the applications implemented in the network N2, are applications that communicate with the outside of the network N2, namely the network N1 here, and the applications D, F, and H are applications that do not communicate with the outside of the network N2. The applications G and H are applications that are not implemented in the example of the in-vehicle communication system 301 shown in FIG. 1, and are registered in advance in the communication/non-communication table T2.

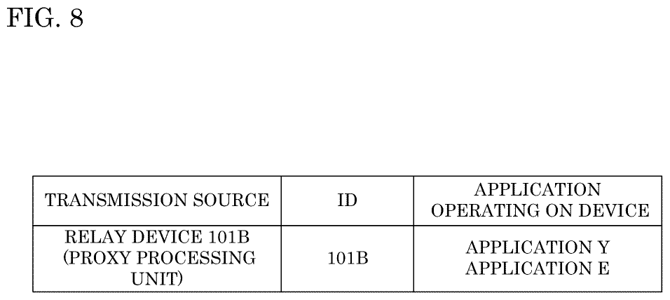

FIG. 8 is a diagram showing an example of functional unit information transmitted by the proxy processing unit in the in-vehicle communication system according to the embodiment of the present disclosure.

Referring to FIG. 8, the proxy processing unit 2 selects functional unit information regarding each of the functional units in the network N2 that communicate with each of the functional units in the network N1 from the acquired functional unit information, and generates aggregate information that includes the selected functional unit information.

More specifically, when receiving the functional unit information shown in FIG. 6, the proxy processing unit 2 selects the applications Y and E that communicate with the network N1 from among the applications Y, D, E, and F indicated by the functional unit information by referencing the communication/non-communication table T2 shown in FIG. 7, generates aggregate information regarding the applications Y and E, and transmits the generated aggregate information as the functional unit information regarding the relay device 101B to the relay device 101A.

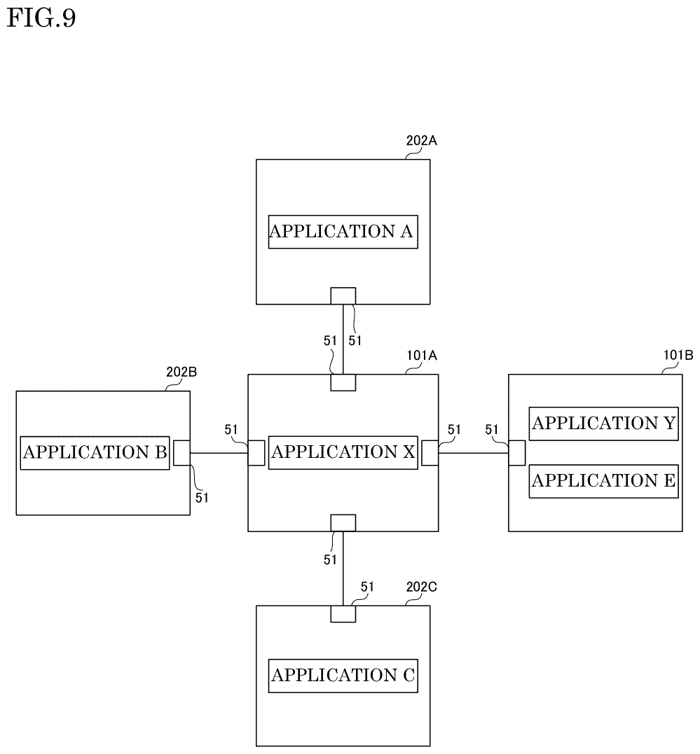

FIG. 9 is a diagram showing an example of information that is used to change network settings in the in-vehicle communication system according to the embodiment of the present disclosure.

Referring to FIG. 9, the relay device 101A generates setting information for each functional unit in a new network based on functional unit information regarding the applications A, B, C, and X acquired from the functional units in the network N1 and functional unit information regarding the applications Y and E acquired from the relay device 101B.

More specifically, the relay device 101A confirms that communication partners of the applications Y and E are the applications B and X, respectively, by referencing the communication management table T1. The relay device 101A then generates setting information including settings of the functional units for the applications Y and E to communicate with the applications B and X, respectively, transmits the generated information to the in-vehicle ECU 202B and the relay device 101B, and changes settings of the relay device 101A.

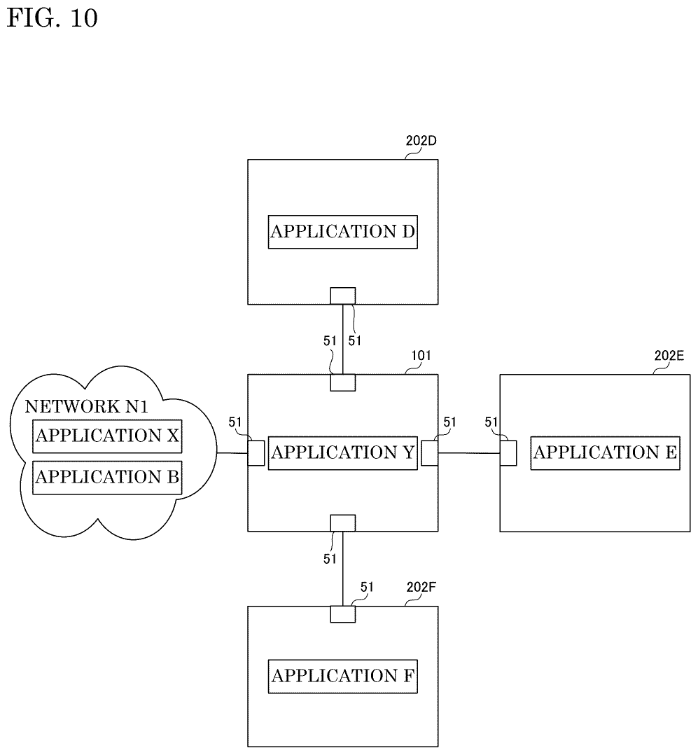

FIG. 10 is a diagram showing an example of information that is used by the proxy processing unit of the relay device according to the embodiment of the present disclosure to perform processing to convert setting information.

Referring to FIG. 10, the proxy processing unit 2 performs conversion processing to convert setting information for the relay device 101B received from the relay device 101A into the settings in the network N2.

Specifically, based on the setting information including the settings relating to the applications Y and E that is received from the relay device 101A and the functional unit information acquired from each functional unit in the network N2, the proxy processing unit 2 checks the in-vehicle ECUs 202 or the relay device 101B in which the applications B and X in the network N1 that are communication partners of the applications Y and E, respectively, and the applications D, E, F, and Y in the network N2 are implemented, as shown in FIG. 10. The proxy processing unit 2 then transmits, to the in-vehicle ECU 202E, a frame including the setting information regarding the application E that is extracted from the setting information received from the relay device 101A, and outputs the setting information regarding the application Y that is extracted from the setting information received from the relay device 101A to the setting unit 4.

### [Operation Flow]

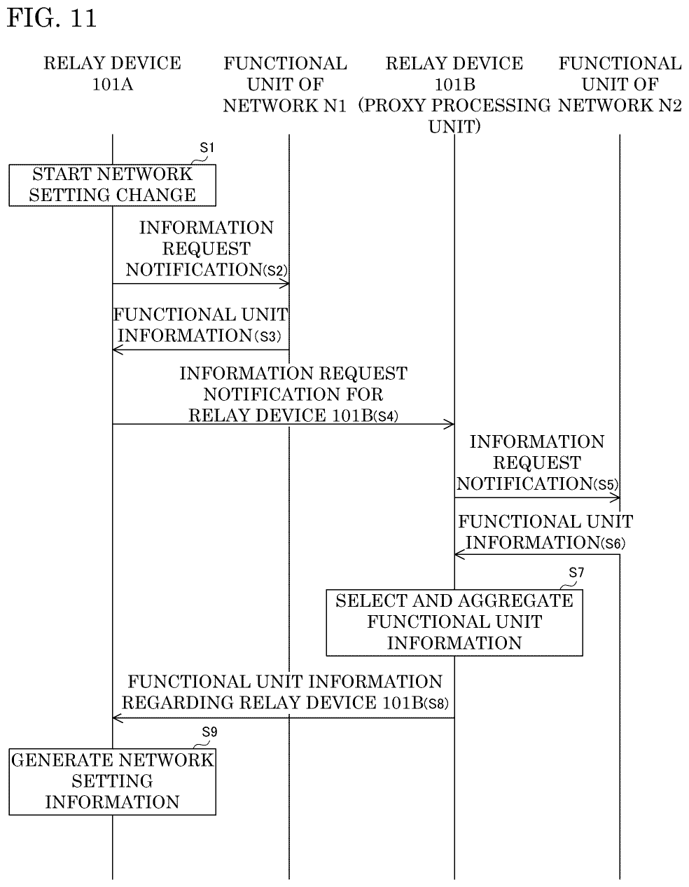

FIG. 11 is a diagram showing an example of a sequence for changing network settings in the in-vehicle communication system according to the embodiment of the present disclosure.

Referring to FIG. 11, first, the relay device 101A starts changing network settings upon the occurrence of a predetermined event that triggers a network setting change (step S1).

Next, the relay device 101A transmits an information request notification to each functional unit in the network N1. The functional unit may be an in-vehicle ECU 202 or the relay device 101A (step S2).

Next, each functional unit in the network N1 receives the information request notification and transmits functional unit information to the relay device 101A. Note that the relay device 101A may acquire its own functional unit information from a storage unit (not shown) (step S3).

Further, the relay device 101A transmits an information request notification to the relay device 101B. This information request notification is a notification for the relay device 101B (step S4).

Next, the proxy processing unit 2 of the relay device 101B receives the information request notification and transmits an information request notification to each functional unit in the network N2. The functional unit may be an in-vehicle ECU 202 or the relay device 101B (step S5).

Next, each functional unit in the network N2 receives the information request notification and transmits functional unit information to the relay device 101B. Note that the relay device 101B may acquire its own functional unit information from the functional-unit-information management unit 3 (step S6).

Next, the relay device 101B generates aggregate information based on the functional unit information received from the functional units by, for example, selecting and aggregating the functional unit information (step S7), and transmits the generated aggregate information as the functional unit information regarding the relay device 101B to the relay device 101A (step S8).

Next, the relay device 101A determines a target functional unit based on, for example, the functional unit information received from each functional unit in the network N1 and the functional unit information regarding the relay device 101B, and generates setting information for each functional unit in the new network (step S9).

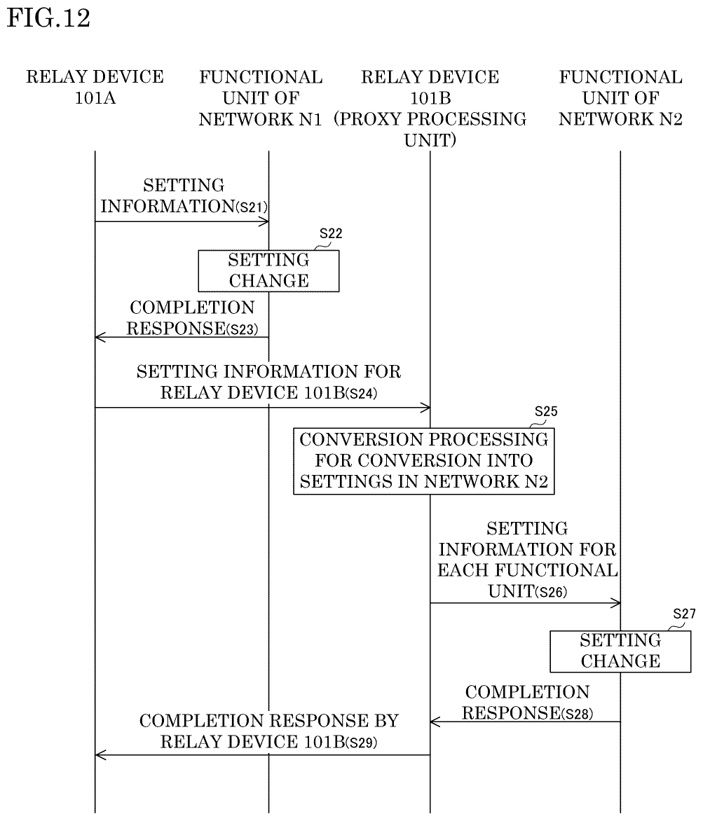

FIG. 12 is a diagram showing an example of a sequence for changing network settings in the in-vehicle communication system according to the embodiment of the present disclosure. FIG. 12 is a continuation of FIG. 11.

Referring to FIG. 12, next, the relay device 101A transmits the setting information for each functional unit to the functional unit in the network N1. This functional unit may be an in-vehicle ECU 202 or the relay device 101A (step S21).

Next, each functional unit in the network N1 changes various settings in accordance with the setting information received from the relay device 101A (step S22), and transmits a completion response to the relay device 101A after completing the setting change (step S23).

Next, the relay device 101A transmits setting information for the relay device 101B to the relay device 101B (step S24).

Next, the relay device 101B performs conversion processing to convert the setting information received from the relay device 101A into settings in the network N2, and generates setting information for each functional unit that is to be subjected to setting processing in the network N2 (step S25).

Next, the relay device 101B transmits the generated setting information to the corresponding functional unit in the network N2. This functional unit may be an in-vehicle ECU 202 or the relay device 101B (step S26).

Next, each functional unit in the network N2 changes various settings in accordance with the setting information received from the relay device 101B (step S27), and transmits a completion response to the relay device 101B after completing the setting change (step S28).

Next, upon receiving the completion response from all the target functional units in the network N2, the relay device 101B transmits a completion response of its own to the relay device 101A (step S29). Thereafter, the relay devices 101A and 101B and the functional units communicate with each other in accordance with the changed settings.

Note that the proxy processing unit 2 is configured to select functional unit information regarding the functional units in the network N2 that communicate with the functional units in the network N1 from the acquired functional unit information, and generate aggregate information including the selected functional unit information. However, there is no limitation thereto. The proxy processing unit 2 may alternatively generate aggregate information including the acquired functional unit information without performing such a selection. In this case, for example, the relay device 101A generates setting information by selecting a part of information included in the functional unit information received from the relay device 101B.

The storage unit 5 may be configured not to store the communication/non-communication table T2 shown in FIG. 7. In this case, for example, the proxy processing unit 2 determines whether or not the functional units in the network N2 communicate with the functional units in the first network by using information on applications or the like in a communication destination included in the functional unit information or the frame received from each functional unit.

The relay device 101A according to the embodiment of the present disclosure is configured to have a function of collecting functional unit information and generating setting information for each functional unit in a new network. However, there is no limitation thereto. Some or all of the functions may alternatively be included in a device other than the relay device 101A in the network N1.

The in-vehicle communication system 301 according to the embodiment of the present disclosure is configured to divide the in-vehicle network 401 into two, but there is no limitation thereto. The in-vehicle communication system 301 may alternatively be configured to include a plurality of relay devices 101B and divide the in-vehicle network 401 into three or more. For example, the in-vehicle communication system 301 can divide the in-vehicle network 401 into the number obtained by adding one to the number of relay devices 101B.

By the way, for example, in a configuration in which settings of a relay device or the like in an in-vehicle network are dynamically changed, the settings need to be designed in advance. When providing variations in the configuration of applications or the configuration of devices in an in-vehicle network, the number of design patterns will become enormous with an increase in the scale of the in-vehicle network.

For example, even when the connection target network is the same, and the same in-vehicle ECU is connected to this network, there are cases where a different network design is required due to differences in the connection target. In addition, as the number of relay devices increases, the delay in transmitting information between in-vehicle ECUs increases, settings for priority control and delay control become more complex, and the number of design patterns increases.

In this regard, for example, the relay device 101B in the in-vehicle communication system 301 behaves as a single functional unit in the network N1 to which its own specific communication port 51 is connected, by bundling communication requests made from the functional units in the network N2 to the network N1. Also, for example, the relay device 101B acts as an SDN (Software Defined Network) controller that dynamically changes network settings by collecting functional unit information and performing notification of the settings, in the network N2 that connects each functional unit with one or more communication ports 51 other than the aforementioned communication port 51.

This configuration makes it possible to divide the in-vehicle network and manage the divided networks. That is, a specific relay device in the in-vehicle network is given a function of making a network present beyond this relay device appear to be a single functional unit including the relay device, and a function of managing the network beyond the relay device. This makes it possible to divide the in-vehicle network into a plurality of networks and manage the divided networks in the in-vehicle communication system. Schematically, if, for example, there are two to the power of ten design patterns, the number of design patterns can be reduced to twice of two to the power of five by dividing the in-vehicle network into two. In the example shown in FIG. 1, it is sufficient to register two to the power of five design patterns to the relay device 101A and register two to the power of five design patterns to the relay device 101B.

Each type of processing (each function) in the above embodiment is realized by a circuitry including one or more processors. The circuitry may be constituted by an integrated circuit or the like that combines one or more memories, various analog circuits, and various digital circuits, in addition to the one or more processors. The one or more memories store programs (instructions) that cause the one or more processors to execute each type of the above processing. The one or more processors may execute each type of the above processing according to the programs read out from the one or more memories, or may execute each type of the above processing according to a logic circuit designed in advance to execute each type of the above processing. The processors may be various processors suitable for computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that a plurality of physically separated processors may cooperate with each other to execute each type of the above processing. For example, the processors installed in a plurality of physically separate computers may cooperate with each other via a network such as a LAN (Local Area Network), a WAN (Wide Area Network), or the internet to execute each type of the above processing. The above programs may be installed in the memories via the network from an external server device or the like, or may be distributed in a state stored on a recording medium such as a CD-ROM (Compact Disc Read Only Memory), a DVD-ROM (Digital Versatile Disk Read Only Memory), or semiconductor memory, and installed in the memories from the recording medium.

The foregoing embodiments are to be construed in all respects as illustrative and not restrictive. The scope of the present invention is defined by the claims rather than the description above, and is intended to include all modifications within the meaning and scope of the claims and equivalents thereof.

The above description includes characteristics described in the following supplementary notes.

### [Supplementary Note 1]

A relay device for use in an in-vehicle network that includes a plurality of functional units,
the in-vehicle network including a first network and a second network,
the relay device including:
a relay unit configured to performs relay processing to relay frames transmitted and received between the functional units in the first network and the functional units in the second network, and frames transmitted and received between a plurality of the functional units in the second network; and
a proxy processing unit configured to act as a proxy for the plurality of functional units in the second network by operating as a communication partner of the functional units in the first network in communicating information regarding setting processing for performing communication in the in-vehicle network,
the proxy processing unit acquires functional unit information regarding each of the functional units in the second network, generates aggregate information that is functional unit information regarding one functional unit based on the acquired functional unit information, and transmits the generated aggregate information as functional unit information regarding the relay device to the first network,
the proxy processing unit generates setting information for each of the functional units to be subjected to the setting processing in the second network, based on the setting information received from the functional units in the first network, and transmits the generated setting information to the corresponding functional unit, and
the setting information includes at least one of filtering, communication bandwidth, frame priority, and a VLAN setting of the relay device being one of the functional units, and a VLAN setting and frame data size of an in-vehicle ECU being one of the functional units.

### [Supplementary Note 2]

A relay device for use in an in-vehicle network that includes a plurality of functional units, the relay device including:
a processing circuit,
the in-vehicle network including a first network and a second network,
the processing circuit being configured to
   relay frames transmitted and received between the functional units in the first network and the functional units in the second network, and frames transmitted and received between a plurality of the functional units in the second network; and
   act as a proxy for the plurality of functional units in the second network by operating as a communication partner of the functional units in the first network in communicating information regarding setting processing for performing communication in the in-vehicle network.

### DESCRIPTIONS OF REFERENCE NUMERALS

1 relay unit
2 proxy processing unit
3 a functional-unit-information management unit
4 setting unit
5 storage unit
51 communication port
101,101A,101B relay device
202,202A,202B,202C,202D,202E,202F in-vehicle ECU
301 in-vehicle communication system
401 in-vehicle network
501 vehicle

1. A relay device for use in an in-vehicle network that includes a plurality of functional units constituted of circuitries,
the in-vehicle network including a first network and a second network,
the relay device comprising:
a relay unit constituted of a circuitry and configured to perform relay processing to relay frames transmitted and received between the functional units in the first network and the functional units in the second network, and frames transmitted and received between a plurality of the functional units in the second network; and
a proxy processing unit constituted of a circuitry and configured to act as a proxy for the plurality of functional units in the second network by operating as a communication partner of the functional units in the first network in communicating information regarding setting processing for performing communication in the in-vehicle network.

2. The relay device according to claim 1,
wherein the proxy processing unit acquires functional unit information regarding each of the functional units in the second network, generates aggregate information that is functional unit information regarding one functional unit based on the acquired functional unit information, and transmits the generated aggregate information as functional unit information regarding the relay device to the first network.

3. The relay device according to claim 2,
wherein the proxy processing unit selects the functional unit information regarding each of the functional units in the second network that communicate with each of the functional units in the first network from the acquired functional unit information, and generates the aggregate information including the selected functional unit information.

4. The relay device according to claim 3, further comprising:
a memory configured to store information indicating a correspondence relationship between the functional units in the second network and whether or not the functional units communicate with the functional units in the first network.

5. The relay device according to claim 1,
wherein the proxy processing unit generates setting information for each of the functional units to be subjected to the setting processing in the second network, based on the setting information received from the functional units in the first network, and transmits the generated setting information to the corresponding functional unit.

6. The relay device according to claim 5,
wherein the proxy processing unit generates setting information for the relay device that is one of the functional units to be subjected to the setting processing, based on the setting information received from the functional units in the first network, and
the relay device further comprises:
a setting unit constituted of a circuitry and configured to perform the setting processing for the relay device, based on the setting information for the relay device that is generated by the proxy processing unit.

7. A communication control method to be performed in a relay device for use in an in-vehicle network that includes a plurality of functional units,
the in-vehicle network including a first network and a second network,
the communication control method comprising:
a step of performing relay processing to relay frames transmitted and received between the functional units in the first network and the functional units in the second network, and frames transmitted and received between a plurality of the functional units in the second network; and
a step of acting as a proxy for the plurality of functional units in the second network by operating as a communication partner of the functional units in the first network in communicating information regarding setting processing for performing communication in the in-vehicle network.

8. A non-transitory computer readable medium storing a communication control program for a relay device for use in an in-vehicle network that includes a plurality of functional units,
the in-vehicle network including a first network and a second network,
the communication control program, when executed by a computer, causing & the computer to function as:
a relay unit configured to perform relay processing to relay frames transmitted and received between the functional units in the first network and the functional units in the second network, and frames transmitted and received between a plurality of the functional units in the second network; and
a proxy processing unit configured to act as a proxy for the plurality of functional units in the second network by operating as a communication partner of the functional units in the first network in communicating information regarding setting processing for performing communication in the in-vehicle network.

9. The relay device according to claim 2,
wherein the proxy processing unit generates setting information for each of the functional units to be subjected to the setting processing in the second network, based on the setting information received from the functional units in the first network, and transmits the generated setting information to the corresponding functional unit.

10. The relay device according to claim 3,
wherein the proxy processing unit generates setting information for each of the functional units to be subjected to the setting processing in the second network, based on the setting information received from the functional units in the first network, and transmits the generated setting information to the corresponding functional unit.

11. The relay device according to claim 4,
wherein the proxy processing unit generates setting information for each of the functional units to be subjected to the setting processing in the second network, based on the setting information received from the functional units in the first network, and transmits the generated setting information to the corresponding functional unit.
